(19) United States
(12) Patent Application Publication
(10) Pub. No.: US 2008/0209697 A1
(43) Pub. Date: Sep. 4, 2008

(54) Fastening Device

(76) Inventor: George Gustaaf Veldhoen, Oud-Alblas (NL)

Correspondence Address: YOUNG & THOMPSON, 209 Madison Street, Suite 500, ALEXANDRIA, VA, 22314, US

(21) Appl. No.: 10/567,409

(22) PCT Filed: Jul. 27, 2004
(86) PCT No.: PCT/NL04/00538

§ 371 Date: May 17, 2008

(30) Foreign Application Priority Data
Aug. 6, 2003 (NL) 1024057

(51) Int. Cl. A44B 17/00; F16B 2/02

(52) U.S. Cl. 24/542; 24/568

(57) ABSTRACT

The invention concerns a fastening device, comprising a first element (1) which in use is attached to a substrate (2) and a second element (5) which, for the purpose of attaching an object (7) to the substrate, can be engaged to interlock with, while remaining capable of being disengaged from, the first element by means of its projection (4; 4a, 4b) that with a gripping edge (8, 10) grips behind a catching edge (3) of the first element (1). Preferably the first and second elements are mutually engaged such that the one element initially is displaced sideways or must be tilted relative to the other element, whereafter the rigid projection can be removed from the first element.

The invention concerns a fastening device (hereinafter referred to as “device”) for the purpose of securely fastening and easily unfastening an object to a substrate, for example a film, and consists of a first element that in use is fastened to the substrate, and a second element, said two elements being executed in such a manner that they can be engaged to interlock while remaining detachable, in particular without the use of tools. The object to be fastened is attached to the substrate by engaging the first and second elements, for which purpose the second element can be pre-attached to said object or, for example, the object can be retained or clamped between the engaged first and second elements. The first and/or second elements can be button-shaped or stud-shaped.

A known apparatus of this type is used for example to secure a tarpaulin to the deck of a boat, or to a motorcar or caravan. In this case the first element is provided with a projection onto which the second element can be fitted while remaining detachable. The projections, which of necessity are permanently attached to, for example, the ship's deck, cause inconvenience and personal injury.

Further related devices are known from DE-A-3248611, DE-A1-19962001, and U.S. Pat. No. 3,818,550.

The purpose of the invention is versatile and concerns a device with one or more of the following properties: it does not easily disengage unintentionally except, preferably, when one of its components fails; it can be engaged and/or disengaged with one hand; it can be engaged and/or disengaged in a single smooth movement; engaging takes place by pressing the first and second elements together; it can be injection-moulded of, for example, synthetic material; it works without using components that flexibly interlock or click into/onto each other and that are subjected to the fastening forces; the first and/or second element can be executed without any projections or hooks, and can for example be given a smoothly finished surface and, if required, can even be fitted partly or entirely recessed; it can be made of a minimum number of components; it can be made in such a manner that the second element is fitted permanently to the object or protected against loss.

For this purpose, the invention is characterised by the attached independent claim(s). The independent claims concern advantageous further developments.

The invention will be explained below in greater detail by reference to the currently most preferred, non-restrictive, embodiments, with reference to the accompanying drawing showing the following:

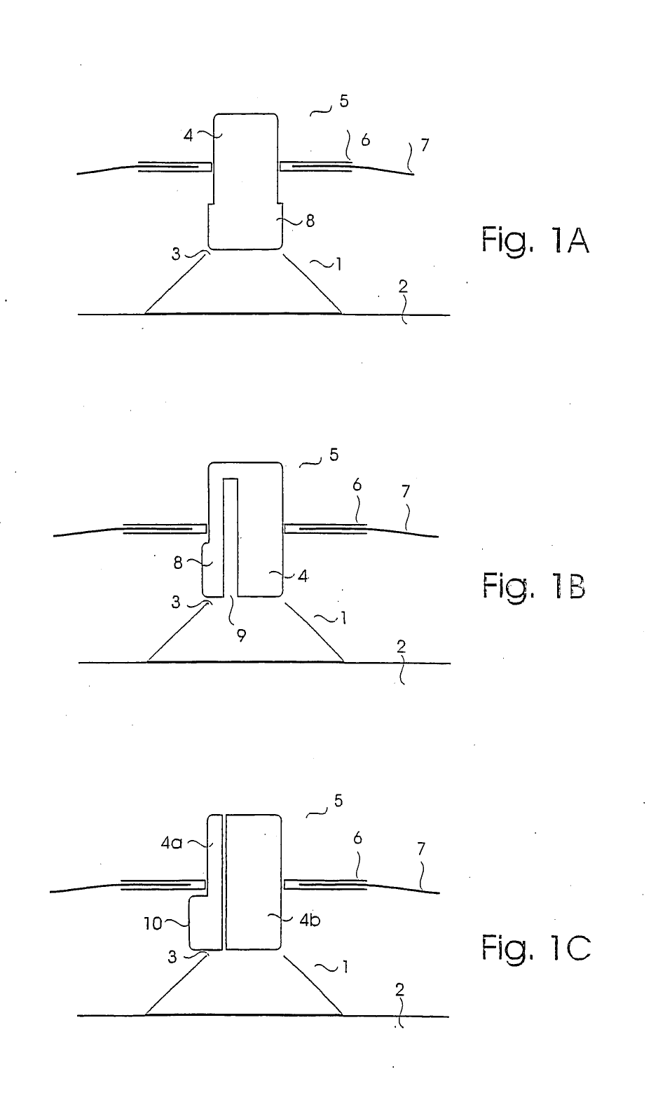

FIG. 1A schematic sectional side view of a detached device

FIG. 1B an alternative in the presentation of FIG. 1A

FIG. 1C a further alternative in the presentation of FIG. 1A

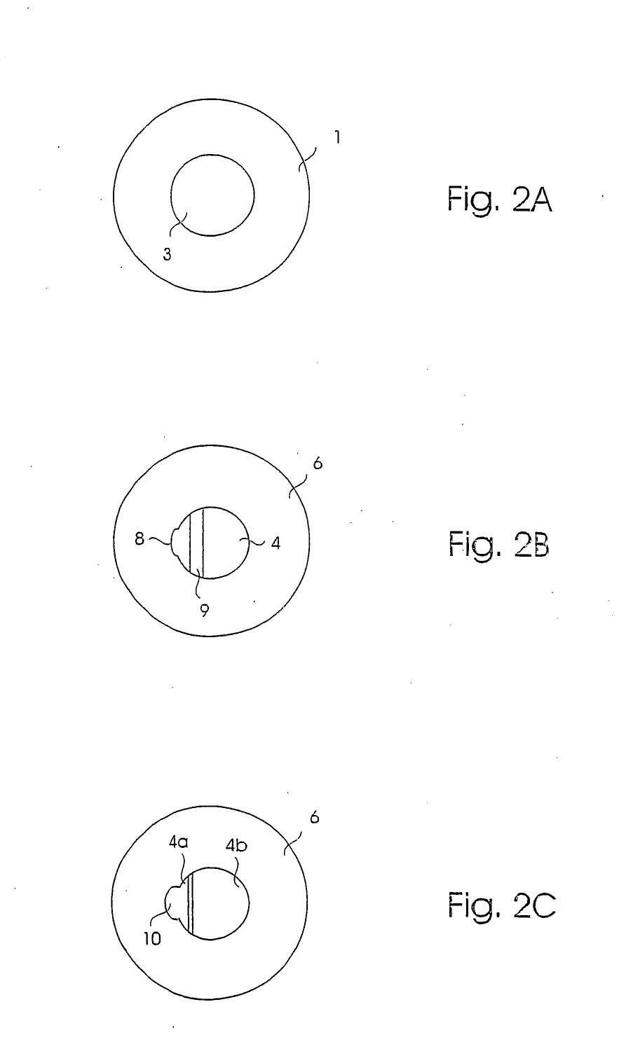

FIG. 2A a top view of the first element

FIG. 2B a bottom view of the second element

FIG. 2C a bottom view of an alternative of the second element

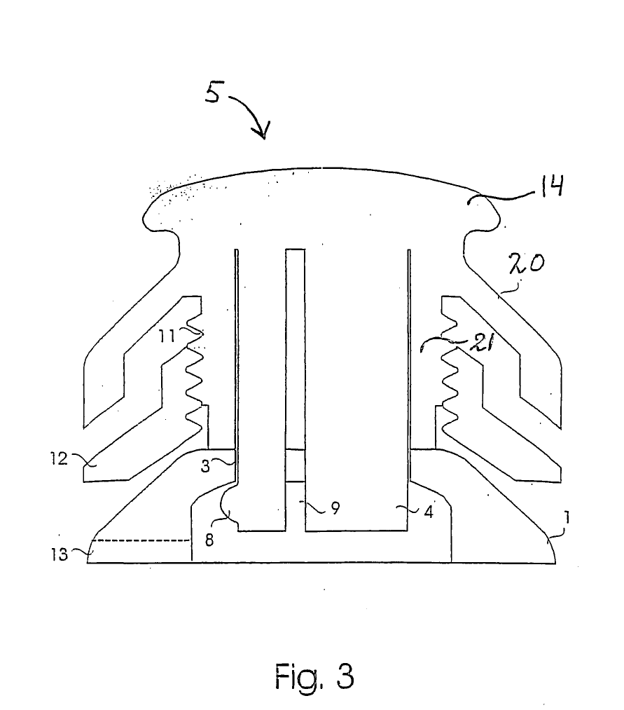

FIG. 3 a sectional side view of another alternative of the device, engaged

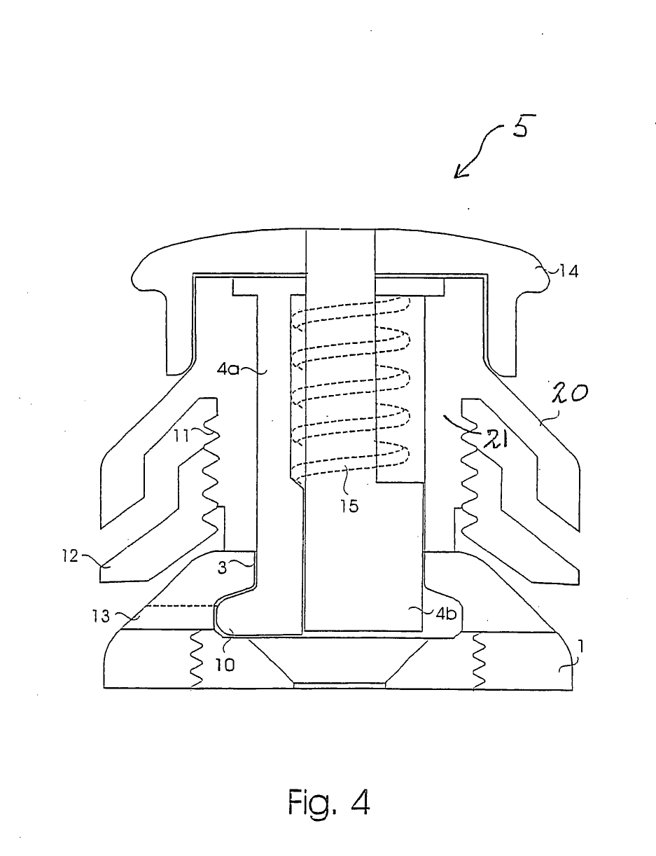

FIG. 4 another alternative of the device in the presentation of FIG. 3

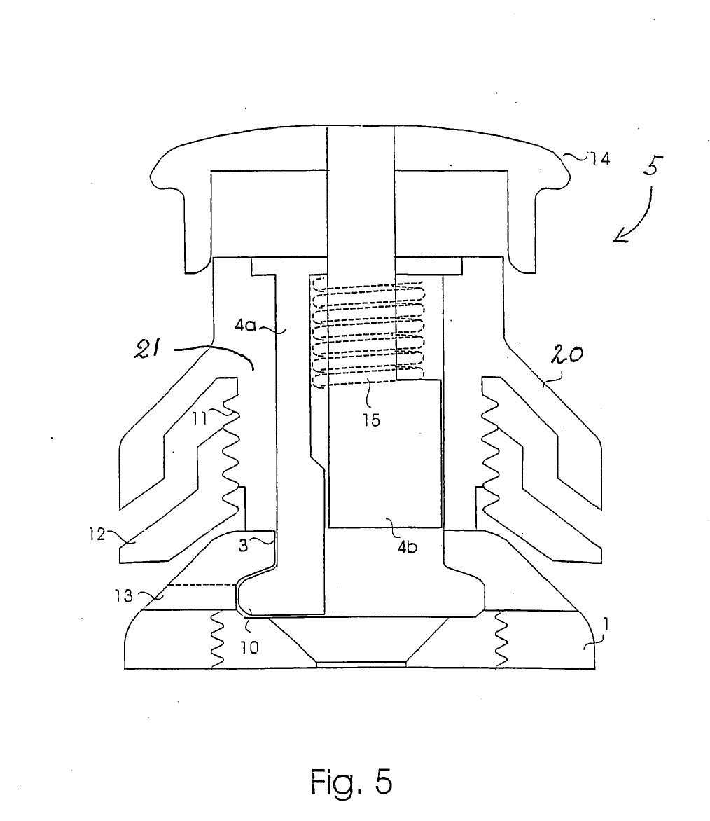

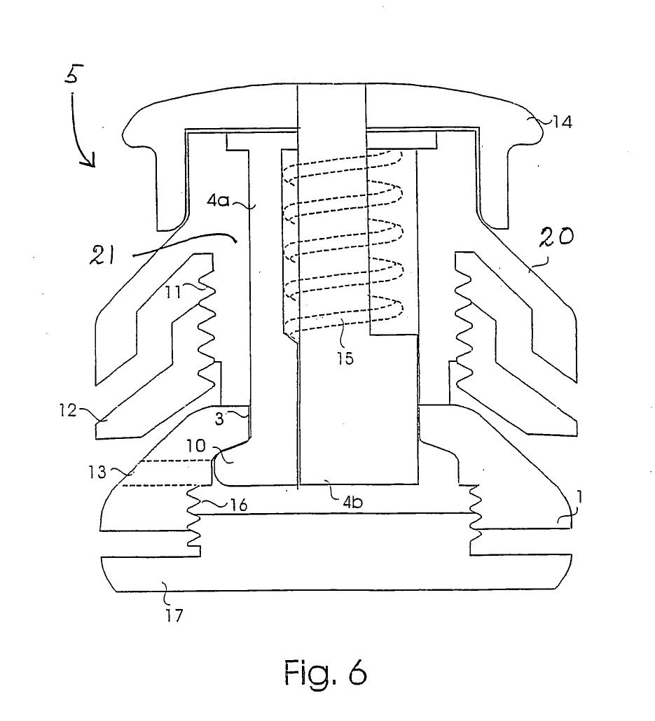

FIG. 5 the alternative of FIG. 4, almost detached FIG. 6 another alternative of the device in the presentation of FIG. 3

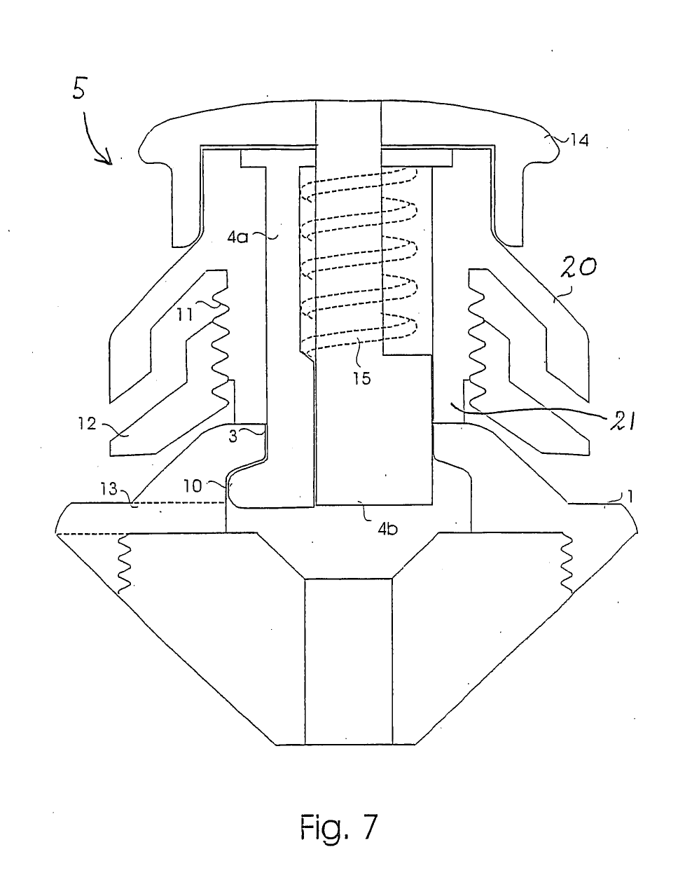

FIG. 7 another alternative of the device in the presentation of FIG. 3

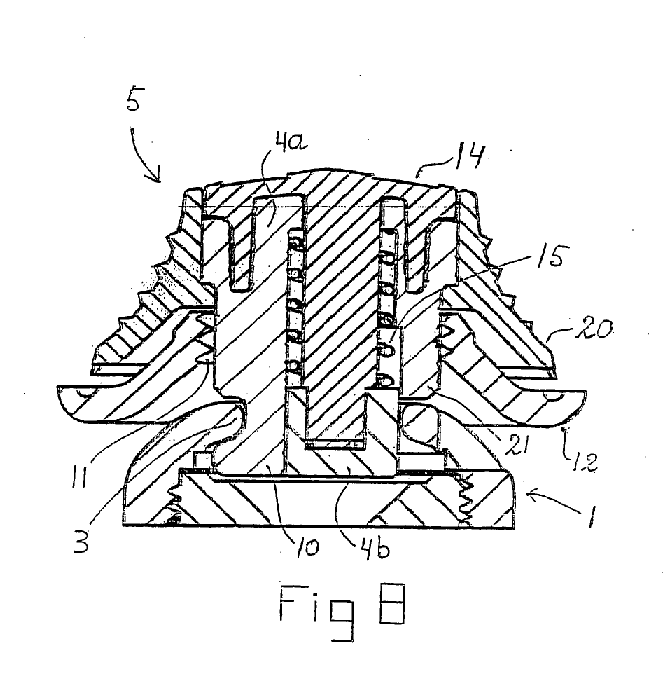

FIG. 8 another alternative of the device in the presentation of FIG. 3

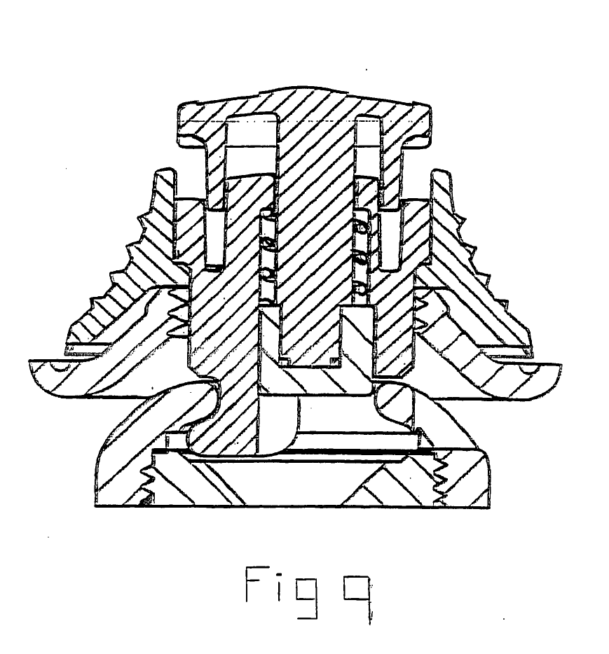

FIG. 9 the alternative of FIG. 8, almost detached, and

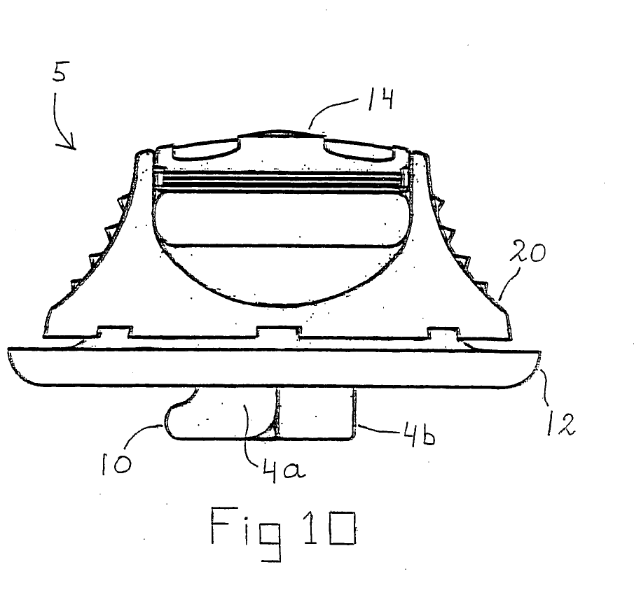

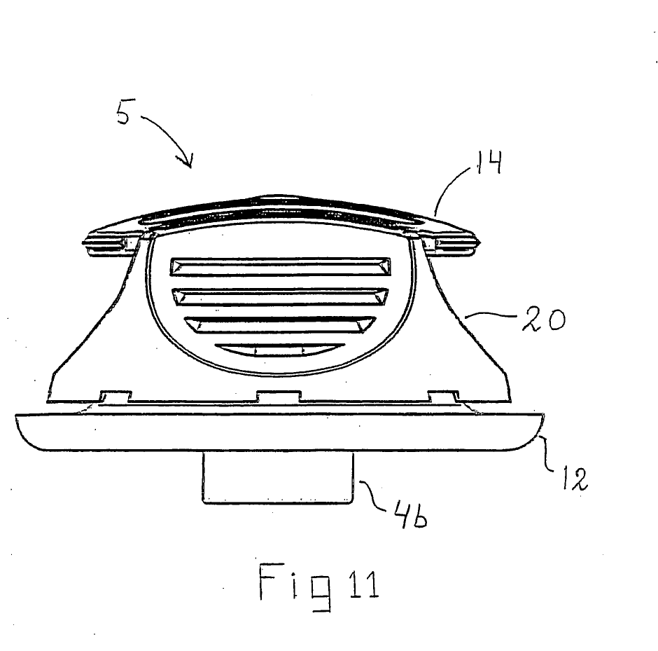

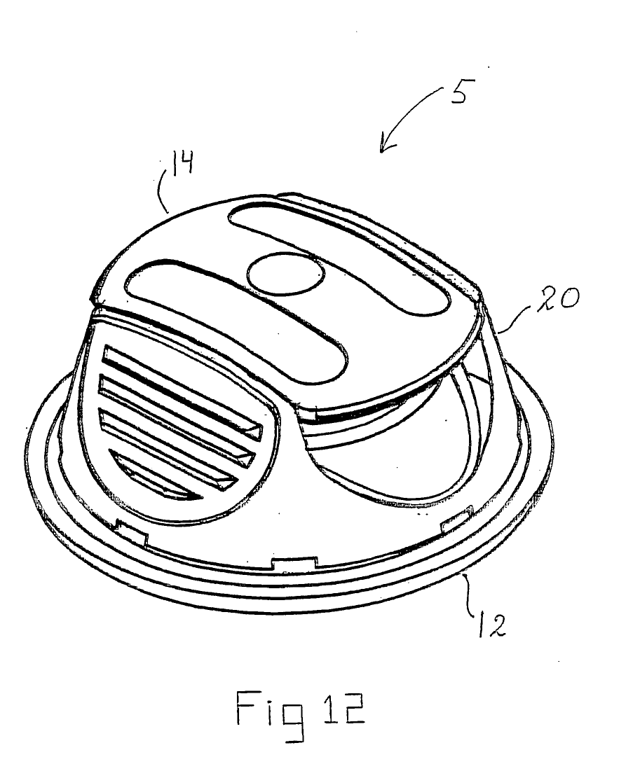

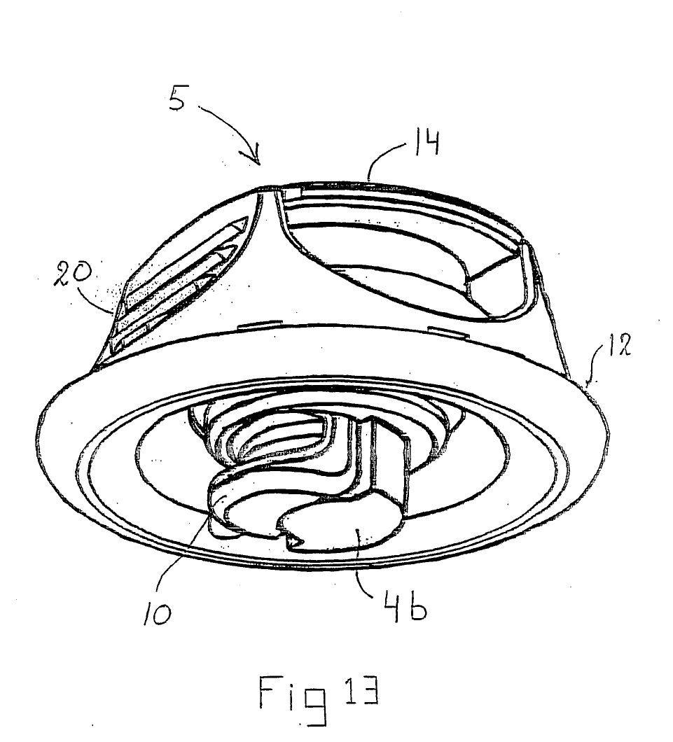

FIG. 10-13 side views and perspective views respectively of the second element

The same references have been used to indicate the same components.

The device according to FIG. 1A comprises a first stud-shaped element 1 that can be attached to a substrate 2, for example by means of an adhesive or screws, which has a radial symmetry, and the top of which comprises an undercut circular aperture 3. Into aperture 3 an aperture-filling part or pin 4 of a second stud-shaped element 5 (not further shown) can be fitted, as a result of which the first and the second elements 1, 5 become engaged. Attached to element 5 (for example, to pin 4) is a ring 6, into which a fabric, leather, or film product 7 is fixed in a known manner. The ring 6 reinforces the edge of the hole in product 7 through which pin 4 projects. Pin 4 is provided with a radial protrusion 8, which in engaged condition prevents the device from becoming disengaged, even under a slight sideways load. The dimensions (diameters) of pin 4, protrusion 8, and aperture 3 are matched so as to ensure that pin 4 closely fits the aperture 3 without deforming and that protrusion 8 cannot pass the edge of aperture 3. While engaging/disengaging during which respectively a compressive force or a tensile force is applied in the axial or longitudinal direction of pin 4, the aperture 3 must elastically expand in a radial direction in order to allow the protrusion 8 to pass through. The device can be used for example to stretch a tarpaulin, provided with second elements 5 along its edge, across an opening in the deck of a boat, the opening in the deck being provided with first elements 1 along its edge. With all pins 4 pressed into the corresponding apertures 3, the tarpaulin is stretched across the opening. The first elements 1 can be manufactured from, for example, stainless steel, brass, or synthetic material, and their height can be very small, no more than a few millimetres, as a result of which they do not constitute obstacles on the deck.

The device of FIG. 1B differs from that of FIG. 1A in that the pin 4 is provided with a longitudinal, asymmetrically located, slot 9, while the protrusion 8 is located on one side of the pin 4 only. Due to the presence of the slot 9, pin 4 has one wide member and one narrow member. During engaging/disengaging the pin 4 can radially contract at the level of protrusion 8 by elastically deforming, thus narrowing slot 9, so that aperture 3 need not deform to allow the protrusion 8 to pass through. The shape of the protrusion 8 and/or the edge of the aperture 3 is such (for example, ramped) that, when pushing/pulling pin 4 in longitudinal direction, at a certain force the (thin) member of pin 4 will automatically be deflected in the direction of the other member.

The device of FIG. 1C differs from that of FIG. 1B in that pin 4 carries a hook 10 projecting sideways at the location of the protrusion 8, while it is longitudinally divided into a narrow member 4a, which carries hook 10, and a wider member 4b. Attached to member 4a is the ring 6, under which hook 10 grips. To engage the elements 1, 5, starting from the presentation of FIG. 1C, member 4b is first raised longitudinally until its lower end is above hook 10, after which member 4a is moved to the right so as to allow hook 10 to be lowered vertically into aperture 3 without deforming pin 4 or aperture 3. Next, member 4a is moved to the left so that hook 10 grips under the rim of aperture 3 and member 4b can be lowered vertically without deforming pin 4 or aperture 3, so that the interlock is mechanically secured. Pin 4 can now no longer be removed from aperture 3 without (permanently) deforming/fracturing components. Instead of a translating movement of member 4a, it can also be tilted to the left in order to insert hook 10 into aperture 3 without deforming. In this embodiment, there is no need to deform/deflect the engaging parts (i.e. aperture 3 and member 4a with hook 10). One, both, or all such parts can therefore be rigid/thick-walled/robust.

FIG. 2A illustrates the first element 1 with a central aperture 3. FIG. 2B illustrates the second element 5 of FIG. 1B, with protrusion 8 and slot 9. FIG. 2C illustrates the second element 5 of FIG. 1C with members 4a, 4b and hook 10.

In the unit illustrated in FIG. 3 (based on FIG. 1B) the embodiment of the second element 5 is such that it can easily be handled and operated with one hand. Element 5 comprises a substantially thin-walled, hollow, cylindrical body 21 with an external thread 11, onto which a ring 12 can be screwed and above which an integral ring 20 is located, so that a film can be clamped between the rings 12, 90. The underside of body 21 is open and its top is closed with an integral, telescoping operating button 14, which radially overhangs on all sides and from which the integral wide and narrow members of pin 4 protrude downwards through and under the body 21. Element 1 is provided with a drain channel 13.

In the unit illustrated in FIG. 4 (based on FIG. 1C) the operating button 14 is a separate part of the element 5, and is pre-tensioned in the released position shown by means of a spiral spring 15. Member 4b is integrated with button 14. Member 4a is integrated with the body 21. To disengage, the button 14 is pulled upwards against the force applied by spring 15 (FIG. 5) so that member 4b is pulled out of aperture 3, after which hook 10 can be removed from aperture 3 as described for FIG. 1C. To engage, with member 4b resting on the top of element 1 and protrusion 10 being positioned fully above aperture 3, ring 20 is pressed down while button 14 remains free, so that body 21 and member 4a move downwards together; element 5 is then moved to the left so that member 4b clicks downwards together with button 14.

The embodiment of FIG. 6 corresponds with that of FIG. 4, but with the first element 1 being provided with an internal thread 16 into which a cap 17 can be screwed, so that a film can be clamped between the first element 1 and cap 17. This embodiment can be used to attach together two objects made of film etc.

The embodiment of FIG. 7 corresponds with that of FIG. 4, with the first element being constructed in such a manner that it can be partly recessed into a substrate not shown, to obtain a robust fastening means with limited protrusion.

FIGS. 8 and 9 constitute another variant of FIG. 4. FIGS. 10-13 illustrate a frontal view, a side view, and top and bottom perspectives of the element 5 of FIG. 8.

In another embodiment based on FIG. 4 (not shown) the button 14 together with the member 4b can for example be removed completely from the body 21. In order to prevent loss of the button 14, it can be attached to body 21, for example by means of a hinge or a flexible connecting wire.

It shall be understood that equivalent components are part of the invention, for example a different type of spring 15, or a different pre-tensioning or reset device 15. The element 15 may be dispensed with, as may the threads.

Other embodiments are also part of the invention, for example embodiments based on one or more separate dispositions of an embodiment disclosed herein, possibly combined with one or more separate dispositions of one or more other embodiments disclosed herein. For example, the element 1 can be made of aluminium.

It shall be understood that the term film is deemed to indicate any flexible and/or pliable structure.

1. Fastening device, comprising a first element (1) that in use is attached to a substrate (2) and a second element (5) that, for the purpose of attaching an object (7) to the substrate, can be engaged to interlock with, while remaining capable of being disengaged from, the first element by means of its projection (4; 4a, 4b) that projects into the first element and that grips behind a catching edge (3) of the first element (1) by means of a gripping edge (8, 10).

2. Device according to claim 1, in which the first and second elements are connected in such a manner that the one element must first be displaced sideways or tilted relative to the other element, after which the rigid projection can be removed from the first element.

3. Device according to claim 1, with means of passage to remove the projection from the first element, for example in which the projection is adapted to be reduced in girth.

4. Device according to claim 1, in which the first element has an aperture (3), behind the rigid edge of which the gripping edge (8,10) grips.

5. Device according to claim 1, in which the projection (4) contains at least two members (4a, 4b) that can be axially displaced relative to each other in order to reduce the girth of the projection.

6. Device according to claim 1, in which the second element (5) comprises two mutually attached, for example slotted or hinged together, parts (14,21) that are mainly axially displaced relative to each other.

7. Device according to claim 1, in which the second element (5) comprises a hand grip (14) with which the means of passage can be operated, for example in which one member (4b) is displaced relative to the other member.

8. Device according to claim 1, in which the gripping edge (8,10) is located on one side of the projection (4) or on one member (4a).

9. Device according to claim 1, in which the second element (5) comprises a button (14) that can be manually moved upwards against the pre-tensioning means (15) and that carries with it a locking part (4b) and has a pressure face (20) with which the second element can be pressed onto the first element (1) while the button is kept free.

10. Device according to claim 1, in which the second element (5) comprises a fastening device or clamping device (12,20) for the purpose of permanently affixing the object to the second element.
